(19) United States
(12) Patent Application Publication
(10) Pub. No.: US 2007/0189203 A1
(43) Pub. Date: Aug. 16, 2007

(54) Method and system for adding clients in push-to-talk over cellular network

(75) Inventors: Sang-Kyung Sung, Seoul (KR); Joon-Goo Park, Yongin-si (KR); Hyeon-Cheol Puh, Suwon-si (KR); Sung-Jin Park, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/409,808

(22) Filed: Apr. 24, 2006

(30) Foreign Application Priority Data
Apr. 22, 2005 (KR) 10-2005-0033682

(51) Int. Cl. H04Q 7/00

(52) U.S. Cl. 370/328

(57) ABSTRACT

A method allows an individual PoC client and a PoC client belonging to a specific PoC group to participate in a session as extended targets while a PoC group talk is proceeding. When the PoC client that is participating in the ad-hoc group talk intends to make the ad-hoc PoC group session ongoing by adding both a plurality of individuals and members of at least one PoC group to the existing session as preliminary talkers, the list information is obtained by identifying the group URI at the PoC server. By using SIP or Extended SIP and XCAP in this process, the PoC user that is participating in the group talk transmits the single SIP message through an ongoing session, and invites a specific PoC group and a plurality of PoC users who are designated voluntarily to the ongoing PoC group talk. Thereby, the PoC user can perform the PoC call.

### CLAIM OF PRIORITY

This application claims the benefit under 35 U.S.C. § 119(a) from an application entitled “METHOD AND SYSTEM FOR ADDING CLIENTS IN PUSH-TO-TALK OVER CELLULAR NETWORK” filed in the Korean Intellectual Property Office on Apr. 22, 2005 and assigned Ser. No. 2005-33682, the contents of which are incorporated herein by reference.

### BACKGROUND OF THE INVENTION

1. Field of the Invention

The present invention relates to a method for adding members of a push-to-talk-over-cellular (PoC) group during a PoC conference session for a group PoC call service, and more particularly, to technology enabling individual PoC users and PoC users identified by a group identity to participate in an ongoing PoC group.

2. Description of the Related Art

Session Initiation Protocol (SIP) or Extended SIP, an application-layer protocol for controlling Internet multimedia communication (IP telephony), is mainly used to transmit session participation information of a group PoC call. And, Extensible Markup Language (XML) Configuration Access protocol (XCAP) is used to obtain information on a group. The basic configuration and functionality of the present invention are based on these protocols and a conventional PoC system. The basic definition, structure and functionality of the conventional PoC system will be described below in detail.

Significant developments in mobile communications technology and the extension of mobile communications networks have resulted in the development of a vast array of services and applications for use with a cellular phone. Concurrently, there is an increasing demand from cellular phone users for additional services, such as a location, multimedia and push-to-talk (PTT) service, is increasing. Among these additional services, the PTT service supports various supplementary functions such as instant messenger and a status display, as well as a group call and a voice call which are also provided by an existing radio or a trunk radio system (TRS).

Standardization of a PoC service that employs the push-to-talk (PTT) function in a mobile communication network is currently taking place. One unique feature of the PoC service that differs from an existing mobile communication service is that a user can participate in a plurality of PoC sessions, and thus, can use a call service while moving among the PoC sessions as desired. This feature is a requirement that is specified in the OMA, which is a forum for specifying mobile communications services.

Meanwhile, the PoC service can accompany a service for establishing a group session as in a conference call. Hence, the OMA specification defines an XML Document Management (XDM) Client (XDMC) and XDM Server (XDMS) for providing a group list service

FIG. 1 is a schematic diagram of XDM architecture. Referring to FIG. 1, user equipment (UE) 10 that requests a PoC service is connected to a Session Initiation Protocol/Internet Protocol (SIP/IP) core 30 that supports SIP and IP multimedia via an access network 20.

The UE 10 is an XDMC capable of residing in a PoC terminal, and includes an XDMC 12 and a PoC client 11 requesting the PoC service.

At this time, the PoC client 11 resides in a PoC user terminal to provide access to the PoC service. The PoC client 11 mainly serves to establish, participate in and terminate the established PoC session. In addition, the PoC client 11 acts to create and transfer a media burst, support an instant personal alert, and authenticate when providing access to the PoC service. Hereinafter, unless otherwise stated, the PoC client 11 is assumed to be the same as a PoC service subscriber.

The SIP/IP core 30 is connected to a shared XDMS 40, a PoC XDMS 50, a PoC server 60, and a presence server 70 in order to support the PoC service.

At this time, the PoC server 60 has a Controlling PoC Function for maintaining and managing the PoC session, or a Participating PoC Function for participating in the PoC session for a one-to-one PoC call or a one-to-two or more PoC call.

The XDMS can be classified into the PoC XDMS 50, which is specific to the PoC service, and the shared XDMS 40, which is commonly used in a different service enabler.

Further, the XDMS includes the Aggregation Proxy 90 that routes a group list relevant request to each XDM server according to a certain rule when receiving the group list relevant request from the XDMC 12. The protocols and details for the XDM, such as creating, modifying and deleting the group list, are well-known among those skilled in the art, and so their detailed description will be omitted herein.

In general, SIP or Extended SIP, an application-layer protocol for controlling Internet multimedia communication (IP telephony), are mainly used to transmit session participation information of the group PoC call.

FIG. 2 shows a schematic configuration of a conventional PoC server. The PoC server performs both a Controlling PoC Function (hereinafter CF) for control of overall maintenance and management of a PoC session, and a Participating PoC Function (hereinafter PF) of controlling maintenance and management between each PoC session, which will be explained below with reference to Tables 1 and 2.

TABLE 1
Controlling PoC Function (CF)

Provides centralized PoC session handling
Provides centralized Media distribution
Provides centralized Talk Burst Arbitration functionality including
talker identification
Provides SIP session handling, such as SIP session origination,
termination, etc.
Provides policy enforcement for participation in group sessions
Provides participant information
Collects and provides centralized media quality information
Provides centralized charging reports
May provide transcoding between different codecs
Supports Talk Burst Control Protocol Negotiation

As shown in Table 1, the PoC server performing the CF (or the Controlling PoC server) serves to manage a PoC session. In particular, the Controlling PoC server receives requests for the floor from PoC clients, arranges an order in which to give the clients the floor, and gives the clients the floor in that order. The Controlling PoC server also distributes a talk burst, for which an arbitrary PoC client makes a request, to all other PoC clients participating in a group PoC call, and provides information of the PoC clients participating in the group PoC call.

As shown in Table 2 below, the PoC server performing the PF (or the Participating PoC server) manages a PoC session between the Controlling PoC server and each PoC client. In particular, the Participating PoC server relays the floor between the PoC client and the Controlling PoC server when the PoC client makes a request for the floor or when the Controlling PoC server gives the floor to the PoC client. In addition, the Participating PoC server relays media between the Controlling PoC server and the PoC client, performs transcoding between different codecs, and filters one of two concurrent PoC sessions according to the choice of a PoC user when there is simultaneous talking in the two active PoC sessions.

TABLE 2
Participating PoC Function (PF)

Provides PoC session handling
May provide the Media relay function between PoC client
and Controlling PoC server
May provide user media adaptation procedures
May provide the Talk Burst control message relay function between PoC
client and Controlling PoC server
Provides SIP session handling, such as SIP session origination,
termination, etc, on behalf of the represented PoC client
Provides policy enforcement for incoming PoC session (e.g. access
control, incoming PoC session barring, availability status, etc.)
May collect and provide media quality information
Provides participant charging reports
May provide filtering of media streams in the case of simultaneous
sessions
May provide transcoding between different codecs
May support Talk Burst Control Protocol Negotiation
Stores the current Answer Mode and Incoming PoC Session Barring
preferences of the PoC client

In the PoC service system described above, the PoC user can input information on groups and their members into a Group and List Management Server (GLMS) through the PoC user's terminal, and can receive information about other PoC users with whom the PoC user can talk through an individual or group list transmitted from the GLMS. Alternatively, in order to create, modify and manage groups and their members, the information on the groups and their members may be input into the GLMS via a communication network, such as the Internet or an Intranet.

In order to use the PoC call service, the PoC user registers his/her PoC address with the SIP/IP core 30. The SIP/IP core 30 stores information on the PoC user by request of the PoC user. Thus, when another PoC user tries to request the group PoC call, the PoC user registers his/her information with the SIP/IP core 30 in advance as described above, and requests the group PoC call to his/her SIP/IP core 30 by using group identification information transmitted from the GLMS. At this time, the SIP/IP core 30 performs addressing and domain locating by using information of the requesting PoC user, and then transfers a PoC call request to a home PoC server 60 with which the requesting PoC user is registered. In regard to the PoC call request, the PoC server 60 prepares to establish a PoC session, obtains each user's information from the GLMS, and then transfers a PoC call request signal to the SIP/IP core 30. When the PoC call request is made to users within an Intradomain, the PoC server 60 performs both the CF and the PF. The PoC server 60 managing the call-requested PoC user requests the PoC call to the PoC user after locating the SIP/IP core 30 by use of the PoC user's information transmitted to the PoC server 60.

FIG. 3 is a schematic diagram for explaining CF and PF blocks of a PoC server. Referring to FIG. 3, PoC clients 111, 121, 131 and 141 provide access to a CF 100 through PFs 110, 120, 130 and 140 respectively, thereby establishing a PoC session. Here, when the floor is granted to a requester qualified as a talker from the CF 100, speech media of the corresponding PoC client is transmitted to each PoC client. At this time, the PoC user who is granted the floor cannot appropriately speak until he/she confirms information of the participants participating in the PoC group session.

Call processing for setting up a PoC call can involve various procedures according to requests and statuses of the originating and terminating sides. The PoC system required by the OMA has the following features.

First, the terminating side can set up its own answering modes according to the request of a PoC user. The answering modes can be either auto or manual. When the terminating side is registered in a PoC user list for the auto answer mode, the terminating side can immediately send an answer to the originating side in a corresponding network in place of the manual answer of a recipient. The automatic answer is sent instead of operating the terminal in the network because the PoC server stores the answering mode and the corresponding user list according to a request of the terminal to set the answering mode. Meanwhile, the manual answer mode corresponds to when the user is not included in an automatic answer user list or where the answer is ambiguous, or when the recipient sets all users to make the manual answer. In the manual mode, a PoC call request is transmitted to the user's terminal through a terminating network and then a call is connected by acceptance of the PoC user.

Second, the PoC system is divided into two modes, an on-demand session mode and a pre-established (or early) session mode, according to the type of connection with a PoC server within a user's home network is set.

The pre-established session mode is designed so that the PoC user sets a session between a PoC client and a PoC server belonging to a PoC user's home network in advance by the PoC user's request. The pre-established session enables the PoC user to negotiate media parameters to be used with the PoC server in advance, and thus advance rapid session establishment without renegotiating the media parameters to be used in the future between the PoC server and client. In order to set the pre-established session, the PoC client provides supported media parameters to a Session Description Protocol Multipurpose Internet Mail Extensions (SDP MIME) body through a SIP INVITE method, and responds to the media parameters provided from the PoC server. The PoC client sends, to the PoC user, identification information of the pre-established session for a response message received from the PoC server, together with a conference Uniform Resource Identifier (URI). When using the pre-established session, it is possible to pre-negotiate such parameters as an IP address, a port number, a codec to be used and a Talk Burst Control Protocol (TBCP) for controlling a talk burst. The on-demand session mode refers to a state in which the PoC user does not set the pre-established session, and indicates that the PoC user performs a PoC call connecting procedure after receiving an invitation message of another PoC user.

Meanwhile, the PoC specification that is being standardized in the OMA has the following features in addition to the aforementioned fundamental functions of the communication system. First, the PoC service supports the multilateral conference function of a half-duplex communication mode, as well as various additional functions according to an objective of the PoC group. Specifically, a PoC conference is divided into an ad-hoc PoC group, a pre-arranged PoC group, and a chat PoC group according to the feature of a participating group. The ad-hoc and pre-arranged PoC groups feature dial-out session establishment for requesting session setup to a conference server and forwarding the session establishment request from a server (conference server) acting as a focus to each client of interest. The chat PoC group features dial-in session establishment and a join procedure with respect to a conference server because each client is aware of information of the session of interest.

Overall, an originating PoC call requester makes a request for call processing by sending a multimedia invitation message using SIP protocol (herein, multimedia includes audio and video), and a terminating side carries out various response procedures according to an answering mode setup of a corresponding PoC server and whether a pre-established session exists. Procedures of originating and terminating networks will be described in detail as follows.

First, an originating PoC client A sends an SIP INVITE request message, which includes the SIP address of a recipient to whom the PoC client A desires to talk, to a corresponding SIP/IP core A. At this time, the INVITE request message includes information such as a PoC address of the call-requesting client, requested media parameters (because the requested session is based on the multimedia, having various media attribute values such as an audio and video encoding method, a rate and a payload type), and an attribute value informing PoC service and so on, and is forwarded to a PF via corresponding IP Multimedia Subsystem (IMS) servers (Proxy Call Session Control Function (P-CSCF) and Serving Call Session Control Function (S-CSCF)) in an IMS network through a route query at a Dynamic Host Configuration Protocol (DHCP) server or Domain Name System (DNS) server. Since the PF, to which a PoC user is connected at a general call request, can be implemented as an entity different from a CF that manages the talk burst of an established session, the INVITE request message forwarded previously is transmitted to the CF via an SIP/IP core of the corresponding network.

A PoC session controlling network including the CF transmits the INVITE request message to the terminating network, and then receives a response message. The SIP response message with which the terminating network responds may be one of a provisional response message of 1XX, a successful response message of 2XX, and an error response message of 4XX, 5XX or 6XX. If an AUTO-ANSWER mode is set, the CF can receive a SIP 183 Session Progress signal, and thus perform connection between the PoC server and the PoC client in the IMS network of the call requester. The call acceptance signal of the recipient responds with the SIP 183 Session Process or SIP 200 OK response and is forwarded to the PoC client A via the CF and PF, the PoC servers. After receiving the 200 OK or 183 Session Progress response from the terminating PoC server, the CF determines that a PoC call is connected and then sends a Floor Granted signal, which gives the talk burst floor to the PoC client A. Granting of the talk burst authority according to the response (200 OK or 183 Session Progress) can be divided into confirmed and unconfirmed. When receiving the unconfirmed response, the CF requires a buffering function.

After receiving the response signal to the INVITE request signal, the originating PoC client A receives the Floor Granted signal forwarding a talk burst transmission enable signal (i.e. a ring back tone) using a Real-time Transport Protocol (RTP) Control Protocol (RTCP). At this time, the Floor Granted signal is generated from the CF having the authority to arbitrate the talk burst, and transmitted to the corresponding PoC client via the PF, which manages the corresponding PoC client. The Floor Granted signal can be transmitted without passing through the SIP/IP core since it uses a bearer's route rather than the SIP. Finally, the PoC user who confirms the ring back tone transmits a media stream (e.g. voice) using an RTP.

FIG. 4 is a schematic diagram for explaining a process of adding PoC clients to a conventional ad-hoc group session, and more particularly, shows a procedure for fetching information on members of a specific PoC group who are to participate in an ongoing group PoC call through independent signaling, and making the members participate in the session using the information.

A PoC user makes a request to a PoC XDMS for the identity of a PoC group that is to be included in a group session through an XDMC, which processes information on a group list in a terminal of the PoC user. At this time, the XDMC transmits a request message of the list information using a target group identity and an XCAP message, and the request message is forwarded to the PoC XDMS, a management server of the group list, via an Aggregation Proxy. The PoC terminal obtaining the list information of the group members prepares a list of XDMCs to be added to the group using a function of the XDMC, and includes the prepared list in the request message of the XDMC, thereby adding the XDMC to an ongoing session.

At this time, the “adding” request message is transmitted using an SIP message. With regard to a corresponding list in the request message, a conference server of the PoC session that is currently proceeding transmits a session request message, and thereby the XDMC can be added.

However, in the foregoing conventional art, a procedure for obtaining a list of SIP addresses of the group members from the XDMS should be performed first, followed by a procedure for editing an address of an individual XDMC to be added after the list information is obtained.

Thus, in order to transmit the SIP message in which the addresses of corresponding XDMCs are all included, a relatively longer transmission time is required.

### SUMMARY OF THE INVENTION

It is an object of the present invention to provide a method for adding clients to a group session by an adding request PoC client transmitting a single session adding message when at least one group is included in an adding target list with respect to an ongoing session.

It is another object of the present invention to provide an SIP Message method for requesting group adding with respect to an individual client and a group that are to be added on the side of a requesting PoC client.

It is yet another object of the present invention to provide a method for recognizing a group identity to be included in a target list by means of a PoC server receiving an adding request, and obtaining information about a constituent client of a corresponding group by means of a PoC XDMS.

According to the present invention, there is provided a method for adding at least one group member to a group session in a push-to-talk-over-cellular (PoC) network, including transmitting a member addition request message for allowing an arbitrary client and/or an arbitrary group to participate in an ongoing session, determining whether a specific address of target address information in the member addition request message corresponds to a group, transmitting a message for obtaining information about the group to a group list server, and obtaining group list information to transmit a session participation message to the group.

According to the present invention, there is provided a system for adding at least one group member to a group session in a push-to-talk-over-cellular (PoC) network, including a PoC system requesting member adding in order to add the member to an ongoing session, and a group list server providing information about a group requested by the PoC system.

According to the present invention, there is provided a push-to-talk-over-cellular (PoC) terminal for adding at least one group member to a group session in a PoC network. The PoC terminal requests the adding from a group list server by adding a specific identity informing that a client and a group of the client that are to be added are identified as a group in order to add the member to an ongoing session, and transmits a session participation message to clients of a corresponding group through group information provided from the group list server.

According to the present invention, there is provided a push-to-talk-over-cellular (PoC) server for adding at least one group member to a group session in a PoC network. The PoC server receives, from a client, a request message for adding the member to an ongoing session, recognizing a client and a group that are to be added to be a group through identities of the client and the group, requests the recognized group from a group list server, and transmits a session participation message to clients of a corresponding group through group information provided from the group list server.

According to the present invention, there is provided a group list server for providing information about at least one group member to be added to a group session in a push-to-talk-over-cellular (PoC) network. The group list server receives from a server a member adding request message for adding the member to an ongoing session, and transmits information about the requested group to the arbitrary server.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a schematic diagram of conventional XDM architecture;

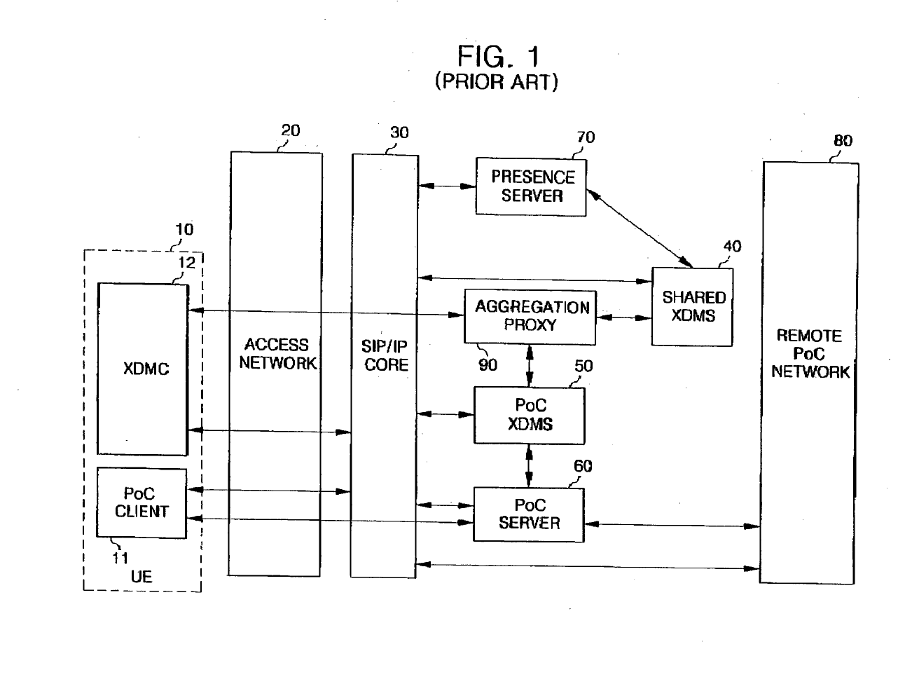

FIG. 2 shows a schematic configuration of a conventional PoC server;

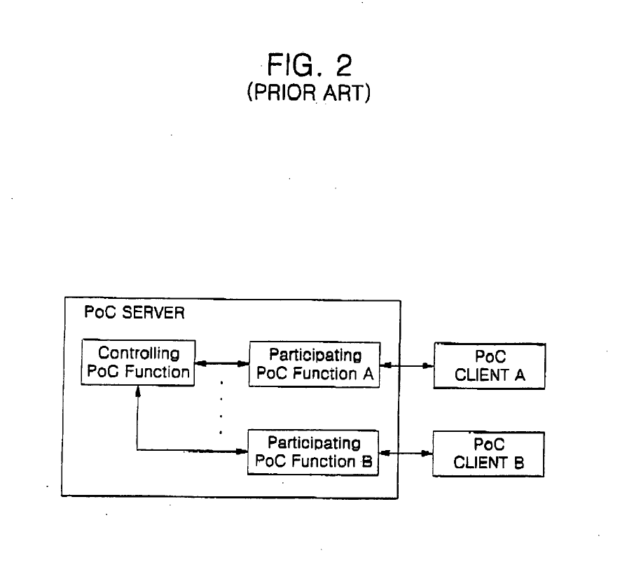

FIG. 3 is a schematic diagram for explaining CF and PF blocks of a conventional PoC server;

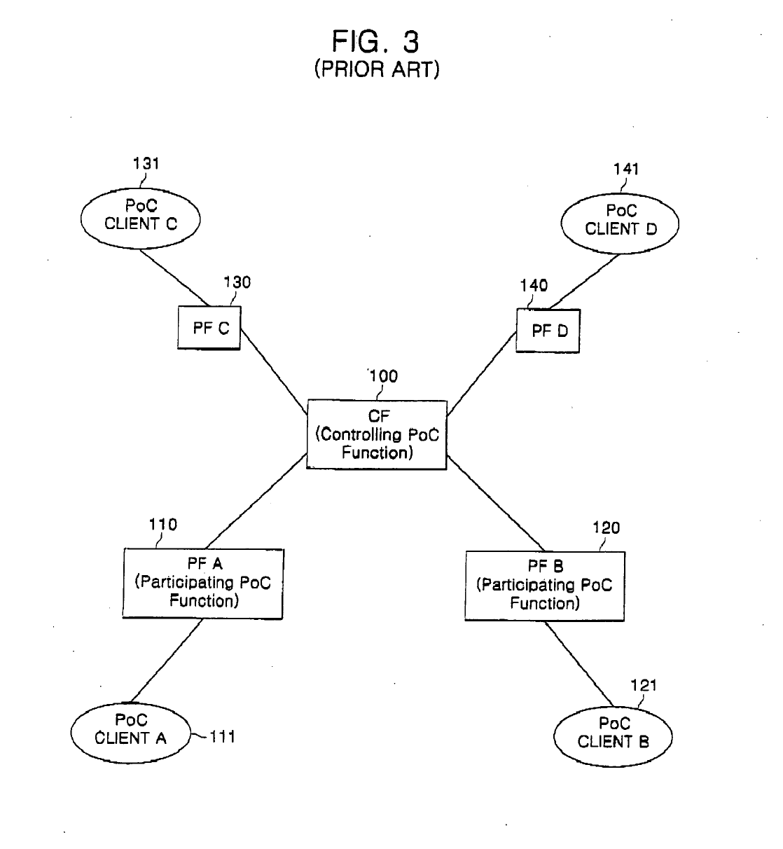

FIG. 4 is a schematic diagram for explaining a process of adding PoC clients to a conventional ad-hoc group session;

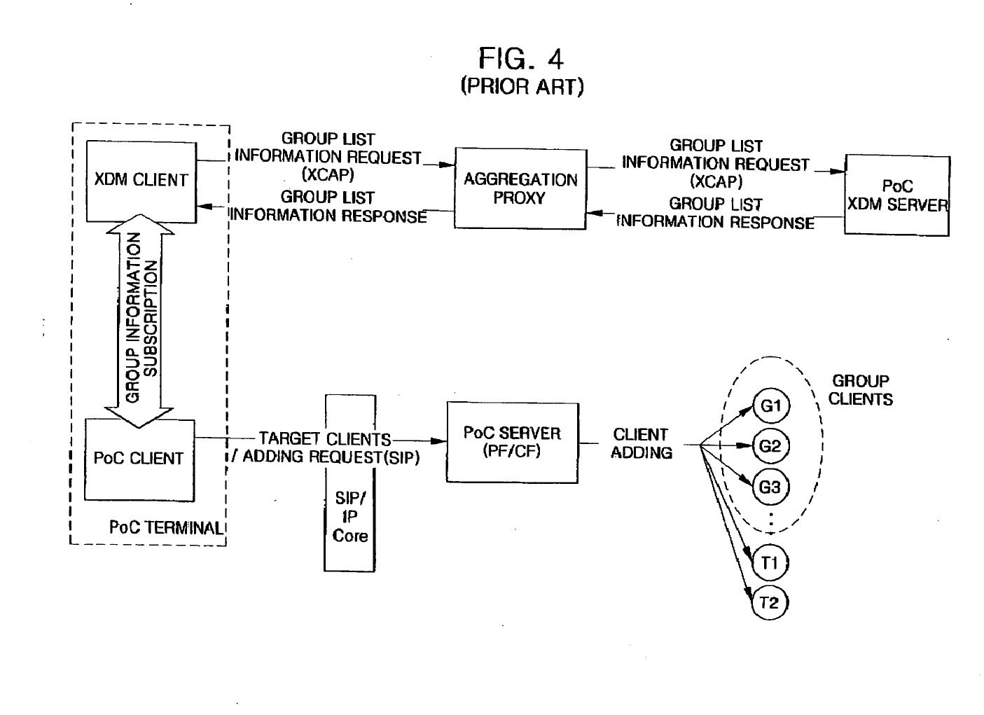

FIG. 5 is a schematic diagram showing a concept of “adding PoC clients” by obtaining information on a group from a server side according to the present invention;

FIG. 6 shows flow of signals for a process for adding a PoC client by obtaining information on a group from a server side in accordance with a first embodiment of the present invention;

FIG. 7 shows a REFER message of FIG. 6;

FIG. 8 shows an HTTP GET message of FIG. 6;

FIG. 9 shows a response message to an HTTP GET message of FIG. 6; and

FIG. 10 shows flow of signals for a process for adding a PoC client by obtaining information on a group from a server in accordance with a second embodiment of the present invention.

### DETAILED DESCRIPTION OF THE PREFERRED EMBODIMENTS

Hereinafter, preferred embodiments of the present invention will be described in fill detail with reference to the accompanying drawings. In the following description, detailed description of well-known functions and configurations has been omitted for the sake of clarity and conciseness.

The present invention may be basically composed of a conventional PoC system including a PoC terminal and a PoC server, a PoC XDMS, and sub-networks (e.g., a SIP/IP core and a radio access network) for connecting the PoC terminal to the PoC server and to the PoC XDMS. The PoC server can act as CF or PF according to whether it owns a group session. The relevant details are the same as in the conventional PoC system, and thus their description will be omitted. Meanwhile, the PoC client can obtain and process information on a group list in cooperation with the XDMC, and establish a group session by application of SIP or Extended SIP. Further, the PoC client receives an RTCP message transmitted to a previously established session, analyzes the received message at an application layer, and allows the PoC user to recognize RTP media as well as other relevant call control information.

According to the present invention, a group is adapted to be identified from group address information (group identity) in a group addition request message of a PoC client which includes addresses of both a group and individual clients, unlike SIP address information of other clients in the list, and a PoC server obtains information on a list of corresponding group addresses through an XDMS and performs the same session connection using the obtained information.

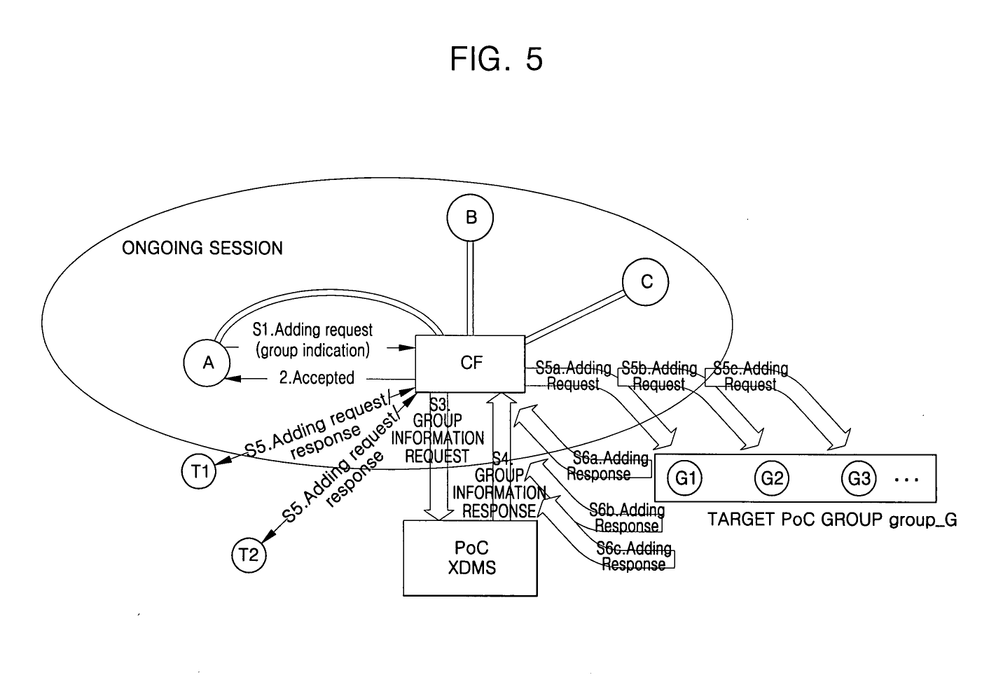

FIG. 5 is a schematic diagram showing a concept of “adding PoC clients” by obtaining information on a group from a server side according to the present invention.

Referring to FIG. 5, when a client A belonging to a PoC session where a group call is being made wants individual PoC clients T1 and T2 and a specific group, group_G, to participate in the PoC session through a single PoC call processing procedure, the client A makes a group member addition request including an indicator indicating a group in SIP address information of the group_G, unlike other SIP address information (S1). At this time, a CF (i.e. a PoC server performing Controlling PoC Function) receiving the request recognizes that the address information corresponds to a group, and then requests information on a list from a corresponding PoC XDMS (S3). Then, the CF sends a session addition request message to the address of the individual PoC client using group list information (i.e. information on SIP addresses of the members G1, G2, G3 of the group_G) transmitted in step S4 (S5,S5a,S5b,S5c).

Meanwhile, the time when the session addition request message is sent to the clients T1 and T2 in the above-mentioned procedure is the same as the time immediately after the list information of the group_G is obtained, but may be earlier than that depending on a policy.

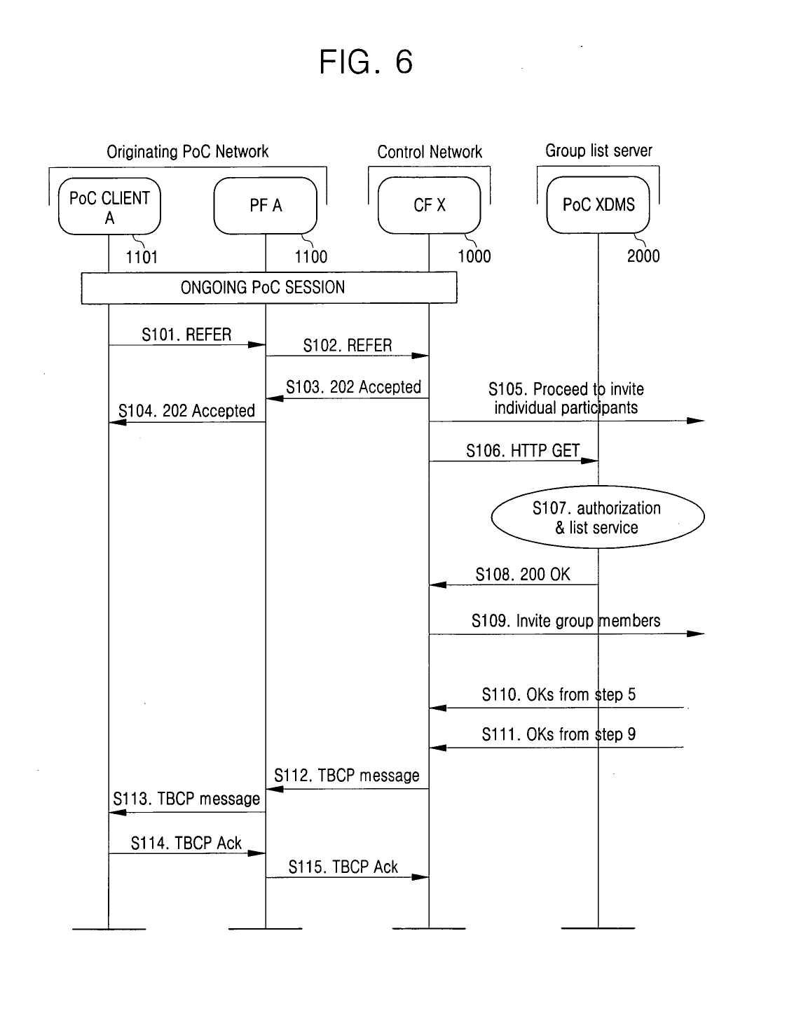

FIG. 6 shows flow of signals for a process for adding a PoC client by obtaining information on a group from a server side in accordance with a first embodiment of the present invention, and shows a detailed procedure for obtaining information on a group list and adding a group using SIP and XCAP.

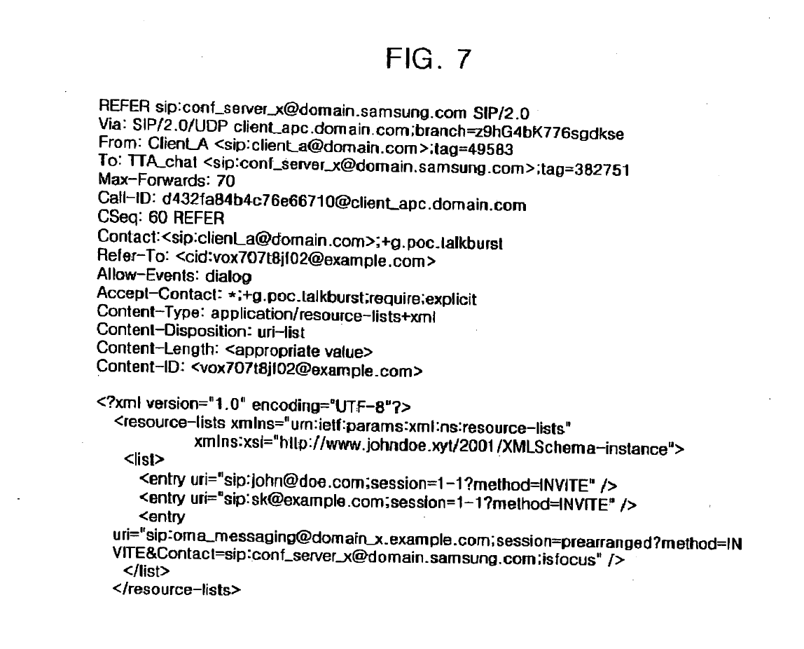

Referring to FIG. 6, a PoC client A 1101 makes a group addition request to an individual client and a group member using a SIP REFER method (S101 and S102), and receives a response (S103 and S104). The SIP REFER message contains an SIP address of the individual client and a group identity (having the form of an SIP URI as an SIP name expressing a group) in a Multipurpose Internet Mail Extension (MIME) portion in REFER. A group indication of the group identity is set by a URI parameter designating a type of session, and its detailed format will be described below with reference to FIG. 7.

Meanwhile, after receiving the group addition request, a CF X 1000 recognizes that a specific URI address is the group identity, and transmits an HTTP GET message in order to obtain the SIP addresses of the group members based on the recognition (S106). A PoC XDMS 2000 managing the group identity determines whether to grant the requested XCAP message based on a stored policy (S107), and responds with a 200 OK response including a list of SIP addresses if granted (S108).

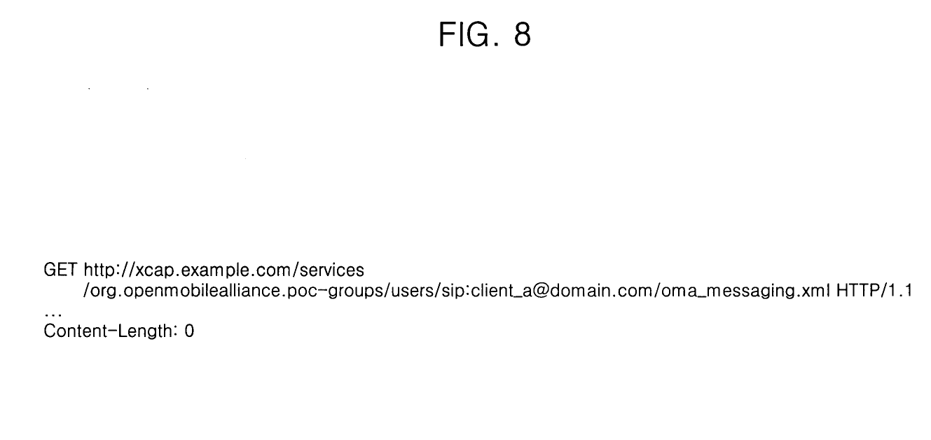

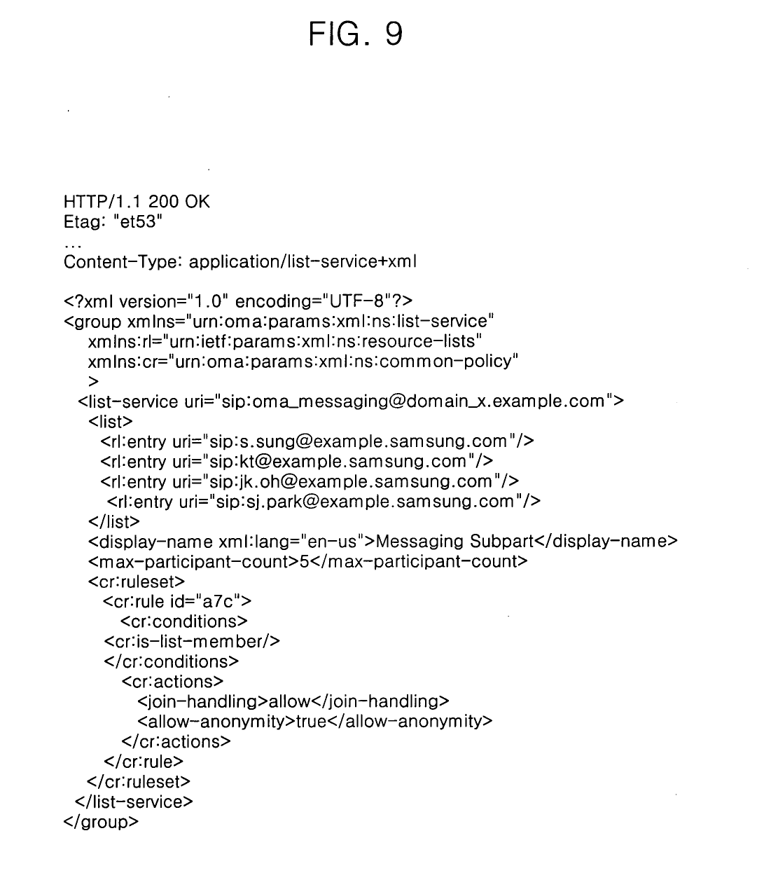

A configuration of the XCAP message in steps S106 and S108 of FIG. 6 will be described with reference to FIGS. 8 and 9.

As in the above-described procedure, after obtaining information on the list of the group to be added, the CF X performs session invitation for each client, the invitations including an option tag informing that the CF X is a conference server (S109), and receives a response, thereby completing the group addition procedure (S110 and S111).

Meanwhile, as set forth above, the invitation to the individual clients to which a session addition request is made together with the group may be processed regardless of a sequence of the invitation to the group, according to a setup of the user or a policy of the server.

FIG. 7 shows a REFER message of FIG. 6.

Main elements of the SIP REFER message, i.e. a “Request URI,” a “Contact” header, a “Refer-To” header, and an MIME portion contained as a field value of the “Refer-To” header are similar to those of the conventional PoC technology, and so their description will be omitted.

In FIG. 7, with respect to first and second entries in the list of the MIME portion, a session type URI parameter is set to “1-1,” and thus it can be indicated that a URI is an individual. With respect to SIP URI information of a third entry “sip:oma_messaging@domain_x.example.com,” the session type URI parameter is set to “prearranged,” and thus it is can be indicated that a corresponding URI is a pre-arranged group.

FIG. 8 shows an HTTP GET message of FIG. 6, and illustrates an XCAP for obtaining group list information. The message of FIG. 8 is a message for the corresponding PoC XDMS obtaining group list information according to “sip:oma_messaging@domain_x.example.com,” which is identified as the group URI in FIG. 7.

FIG. 9 shows a response message to an HTTP GET message of FIG. 6, and illustrates group list information transmitted in response to an HTTP GET message requested in FIG. 8. Referring to FIG. 9, each piece of URI information provided for a group list service is transmitted in addition to a “list,” and a “ruleset” including a session participation policy of the URI may be additionally transmitted.

Meanwhile, the procedure of FIG. 6 is illustrative of the technology of the PoC XDMS obtaining the group list information using the XCAP in the method of the PoC server obtaining the group list information. However, based on the possibility of extension of the PoC system in the future, the group list (e.g. a book of addresses used in the PC and a mailing list used for e-mail) of an Internet domain can be obtained through a web interface.

Thus, a web list server can take the place of a function of the PoC XDMS for the first embodiment. In this manner, the web list server takes control of the function of the PoC XDMS, which will be described below as a second embodiment.

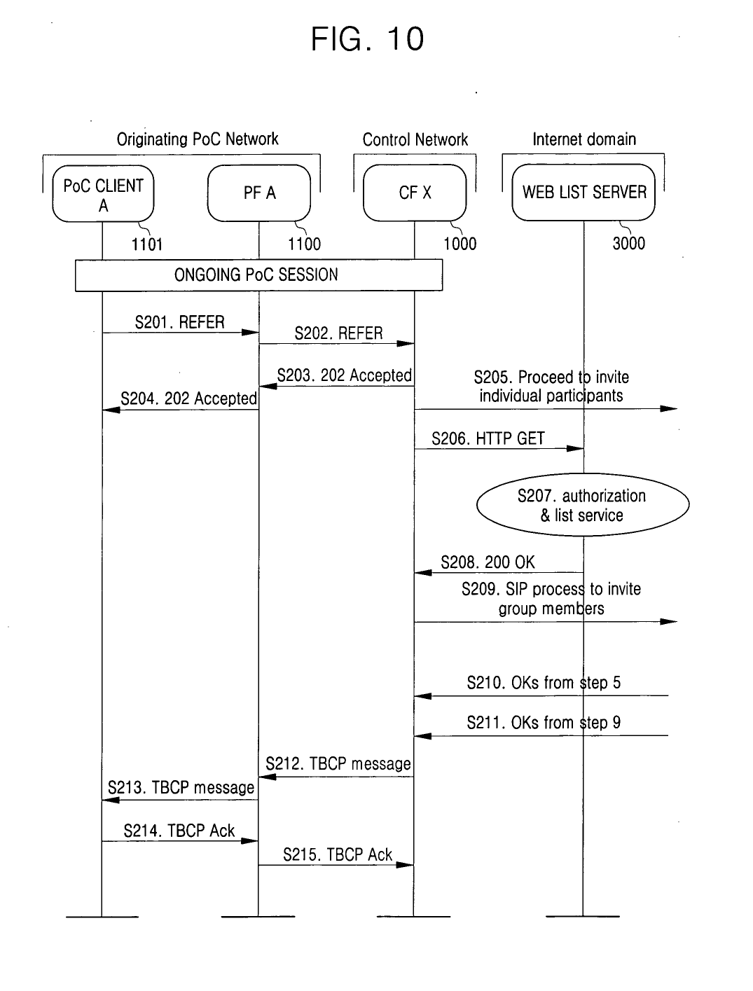

FIG. 10 shows flow of signals for a process for adding a PoC client by obtaining information on a group from a server in accordance with a second embodiment of the present invention, and illustrates a method of receiving group list information from an ordinary address on an Internet region rather than a PoC XDMS.

In FIG. 10, a procedure of obtaining group member information using a group list server on this web is shown. At this time, a corresponding web server may be an information terminal such as a PC, a PDA or the like.

FIG. 10 differs from FIG. 6 only in that a web list server 3000 is used instead of the PoC XDMS 200 used in FIG. 6. Since the two examples are otherwise the same, description of the procedure of FIG. 10 will be concluded here.

In the first and second embodiments, the PoC group is limited to the case where there is no restriction in adding the member to the session so far as the policy of the group is concerned (e.g. the ad-hoc group and the open chat group). If the user who makes the member addition request is the host or manager of the session, the principle of the present invention can be applied irrespective of the group feature.

The present invention provides the method for obtaining the list information by identifying the group URI at the PoC server when the PoC client participating in the ad-hoc group talk intends to make the ad-hoc PoC group session ongoing by adding both a plurality of individuals and members of at least one PoC group to the existing session as preliminary talkers.

By using the present invention, the PoC server client participating in the group talk transmits the single session addition message (SIP REFER) through the ongoing session, and invites the preset specific PoC group and the arbitrary individual PoC user to the ongoing PoC group talk, so that it can perform the PoC call.

This lowers a traffic burden in the wireless access section suitable for the mobile environment, provides a more effective group talk procedure from a user point of view, and reduces a need to store all group URI list information in the PoC terminal.

While the present invention has been described with reference to the preferred embodiments, it should be understood to those skilled in the art that various other modifications and changes may be provided within the spirit and scope the present invention defined in the following claims.

What is claimed is:

1. A method for adding at least one group member to a group session in a push-to-talk-over-cellular (PoC) network, the method comprising the steps of:
transmitting a member addition request message for allowing a client or a group to participate in an ongoing session;
checking whether a specific address of target address information in the member addition request message corresponds to a group;
transmitting a message for obtaining information about the group to a group list server; and
obtaining group list information to transmit a session participation message to the group.

2. The method according to claim 1, wherein the member addition request message is provided in the form of an SIP address when the member to be added is a client.

3. The method according to claim 1, wherein the member addition request message is provided as a group identity when the member to be added is a group.

4. The method according to claim 1, wherein the member addition request message uses a REFER message.

5. The method according to claim 1, wherein the step of transmitting the message for obtaining the information about the group includes using a Hypertext Transfer Protocol (HTTP) GET message.

6. A system for adding at least one group member to a group session in a push-to-talk-over-cellular (PoC) network, the system comprising:
a PoC system for requesting the addition of a member adding in order to add the member to an ongoing session; and
a group list server for providing information about a group requested by the PoC system.

7. The system according to claim 6, wherein the PoC system includes a client transmitting a request message for adding the member, and a PoC server requested by the client for the addition of a member through a REFER message.

8. The system according to claim 6, wherein the group list server is requested by a conference server of the PoC server for the group information through a Hypertext Transfer Protocol (HTTP) GET message.

9. The system according to claim 6, wherein the group list server uses a PoC Extensible Mark-up Language Document Management Server (XDMS).

10. The system according to claim 6, wherein the group list server uses a web list server.

11. A push-to-talk-over-cellular (PoC) terminal for adding at least one group member to a group session in a PoC network, the PoC terminal comprising:
means for requesting the adding of the at least one group member from a group list server by adding a specific identity informing that a client and a group of the client that are to be added are identified as a group in order to add the member to an ongoing session; and
means for transmitting a session participation message to clients of a corresponding group through group information provided from the group list server.

12. A push-to-talk-over-cellular (PoC) server for adding at least one group member to an ongoing group session in a PoC network, the PoC server comprising:
means for receiving from a client a request message for adding the at least one group member to the ongoing group session;
means for recognizing a client and a group that are to be added to be a group through identities of the client and the group;
means for requesting the recognized group from a group list server; and
means for transmitting a session participation message to clients of a corresponding group through group information provided from the group list server.

13. A group list server for providing information about at least one group member to be added to a group session in a push-to-talk-over-cellular (PoC) network, the group list server comprising:
means for receiving from a server a member adding request message for adding the member to an ongoing session; and
means for transmitting information on groups that are requested to be added to the ongoing session to the server.
